(19) United States
(12) Patent Application Publication
(10) Pub. No.: US 2011/0221246 A1
(43) Pub. Date: Sep. 15, 2011

(54) VEHICLE SEAT

(75) Inventors: Andrew Downie, Cheshire (GB); Paul Sharman, Leicestershire (GB); Nicholas Stapleton, Cheshire (GB); Steven Macmanus, Warwickshire (GB)

(73) Assignee: BENTLEY MOTORS LIMITED, Cheshire (GB)

(21) Appl. No.: 13/129,911

(22) PCT Filed: Nov. 20, 2009
(86) PCT No.: PCT/GB09/51577

§ 371 Date: May 18, 2011

(30) Foreign Application Priority Data
Nov. 20, 2008 (GB) 0821189.8

(51) Int. Cl. B60N 2/427

(52) U.S. Cl. 297/216.1

(57) ABSTRACT

A vehicle seat having means (24) arranged to positively displace a part of the seat relative to either another part of the seat and/or a vehicle in which the seat is mounted, in the event that predetermined conditions corresponding to a vehicle impact are encountered. The seat may be displaced by an actuator trigger by an electronic control unit in dependence on conditions sensed by one or more vehicle impact sensors.

The present invention relates to a vehicle seat, and particularly but not exclusively to an automotive vehicle seat.

Automotive vehicle seats typically provide for a whole range of adjustments aimed at enhancing occupant comfort and safety. These adjustments typically include forwards and backwards movement to enable the position of the seat on the longitudinal axis of a vehicle to be adjusted, upward and downward movement to enable the position of the seat on the vertical axis of a vehicle to be adjusted and pivotal movement of a seat squab part relative to the cushion part to enable rake of the squab relative to the seat to be adjusted.

The mechanisms inherent to the provision of these adjustments impart a degree of play or compliance to a seat. This presents a problem under vehicle impact conditions in that movement of a seat relative to a vehicle as a result of compliance in its adjustment mechanisms will contribute to movement of an occupant of the seat relative to the vehicle during impact conditions. This movement generally counters the intended effects of safety devices such as seat belts and airbags intended to restrain and control movement of a vehicle occupant during an impact and can therefore increase the risk of an occupant incurring an injury.

As automotive vehicle seats have become more complex so their mass has increased and this exacerbates the problem since the increased mass results in increased forces being generated by the seat when a vehicle is involved in an impact. The problem is further exacerbated where a vehicle seat is provided with an integrated seat belt mounted on the seat rather than directly to the vehicle. With this arrangement force applied to the seat belt by an occupant during a vehicle impact is transmitted to the vehicle seat rather than directly to the vehicle. This further increases the load upon the seat and generates further compliance in and therefore movement of the seat relative to the vehicle.

Embodiments of the present invention have been made in consideration of these problems.

According to an aspect of the present invention there is provided a vehicle seat comprising a means arranged to positively displace a part of the seat relative to either another part of the seat and/or a vehicle on which the seat is mounted in the event that predetermined conditions corresponding to a vehicle impact are encountered.

According to another aspect of the present invention there is provided a method of counteracting the effects of a vehicle impact on the vehicle seat comprising positively displacing a part of the vehicle seat relative to either another part of the seat and/or a vehicle in which the seat is mounted when certain predetermined conditions corresponding to a vehicle impact are encountered.

Introducing a positive displacement to at least part of a seat can reduce or eliminate net movement of that or another part of the seat relative to a vehicle in which it is mounted. Consequently movement of a seat occupant is also reduced, which in turn helps to reduce the risk of injury resulting from impact of the occupant with the vehicle structure.

Preferably said positive displacement is arranged to at least part offset movement of the seat due to forces generated by vehicle impact conditions.

The means arranged to positively displace may comprise an actuator, such as a gas operated piston and cylinder arrangement which could be driven by an explosive charge or some other suitable gas generator. The actuator may be mounted between components of the seat and/or between the seat and a vehicle on which it is mounted. The actuator may be arranged to operate an adjustment mechanism arranged to adjust the relative position of parts of the seat, and/or of the seat relative to a vehicle in which it is mounted. The adjustment mechanism may comprise two pivotally connected members, in which case the actuator may be arranged to move the members pivotally relative to one another. A locking means may be provided to lock the seat and/or components of the seat in a normal and/or displaced state. The locking means may comprise cooperating components and may include a ratchet.

The actuator may be triggered by an electronic control unit arranged to trigger the actuator in dependence upon vehicle impact conditions as sensed by one or more vehicle impact sensors. In this case it is preferable that the actuator is triggered within at least 10 ms (milli seconds) of the beginning of an impact event.

In one embodiment the seat comprises a cushion and a squab and the means is arranged to displace the front part of the cushion upwardly relative to a vehicle on which the seat is mounted. This causes the seat to pivot about the rear of the cushion and causes the seat squab to move backwards (for a front facing seat) relative to the vehicle, counteracting the tendency of the squab to move forwards due to compliance in the seat structure under frontal impact conditions.

In order that the invention may be more clearly understood embodiments thereof will now be described, by way of example, with reference to the accompanying drawings of which:

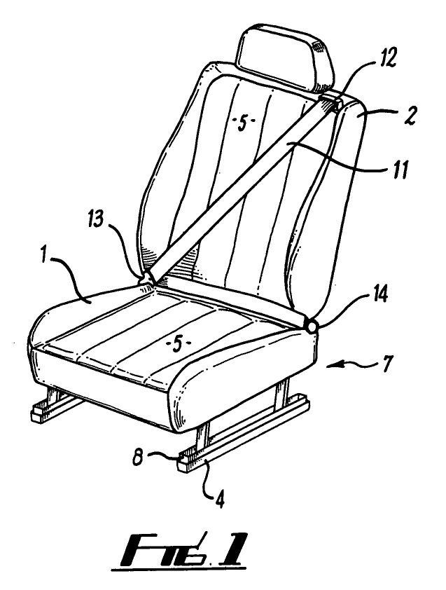

FIG. 1 shows a diagrammatic perspective view of a vehicle seat according to the invention;

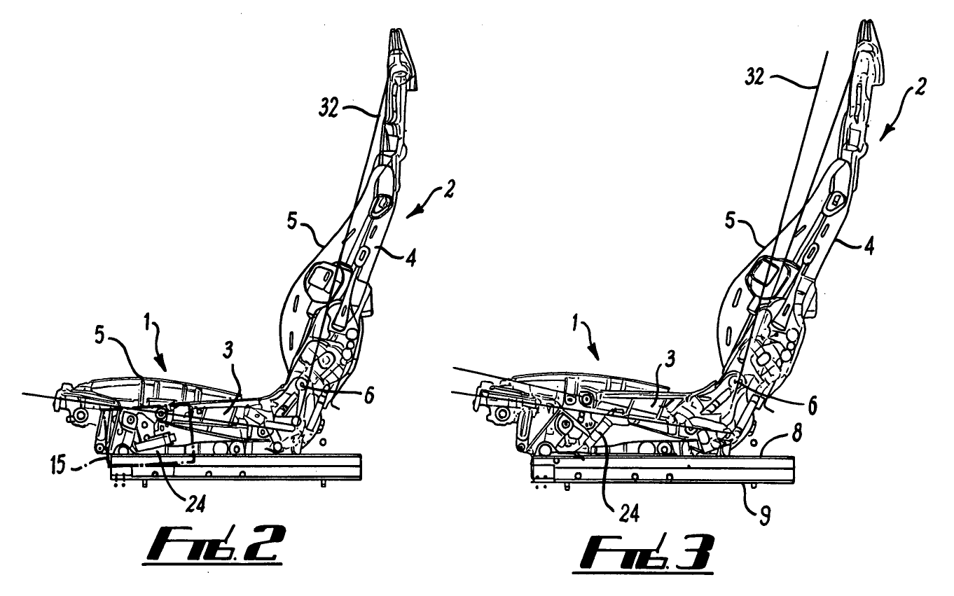

FIG. 2 shows a partial cut-away left side view of the seat of FIG. 1 in a normal position;

FIG. 3 shows the view of FIG. 2 following deployment of the actuator to raise the front of the seat cushion;

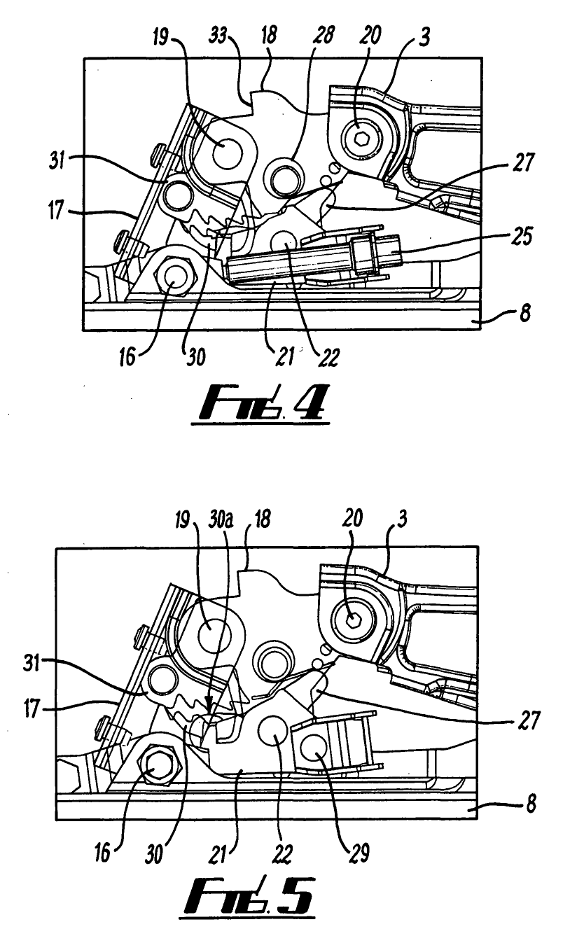

FIG. 4 shows an enlarged and simplified view of the actuator and associated components of the seat of FIG. 2 generally in box 15 of that Figure;

FIG. 5 shows the view of FIG. 4 without the actuator;

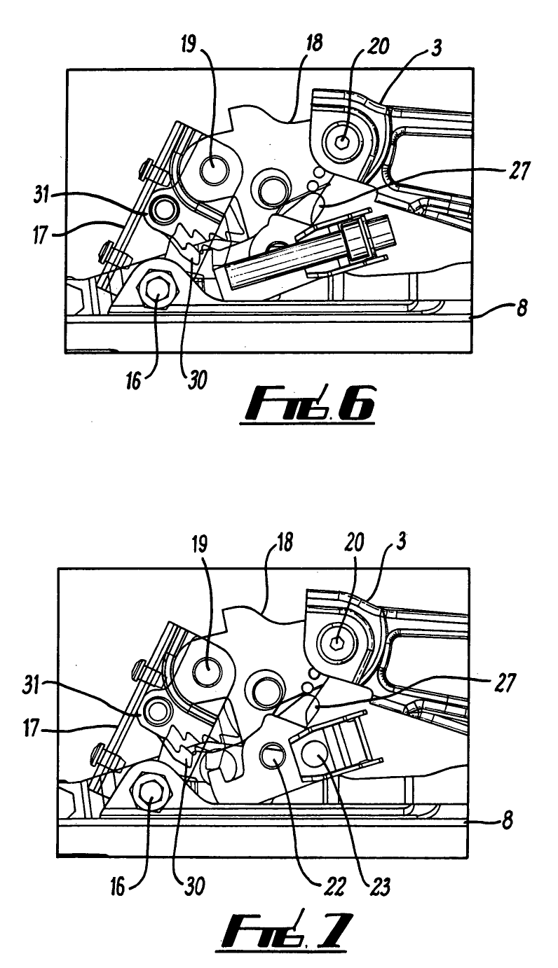

FIG. 6 shows the view of FIG. 4 with the actuator in an initially deployed state;

FIG. 7 shows the view of FIG. 6 without the actuator;

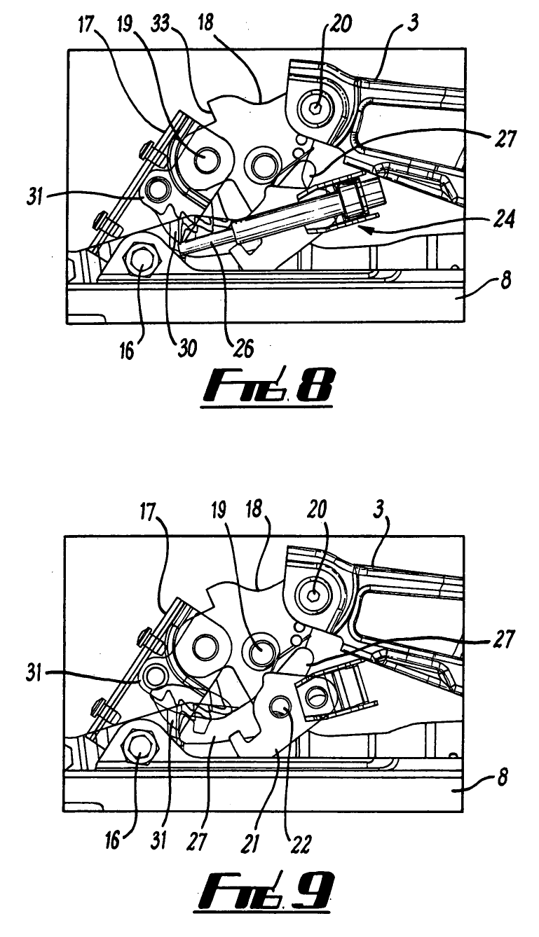

FIG. 8 shows the view of FIG. 4 with the actuator in a partially deployed state;

FIG. 9 shows the view of FIG. 8 without the actuator;

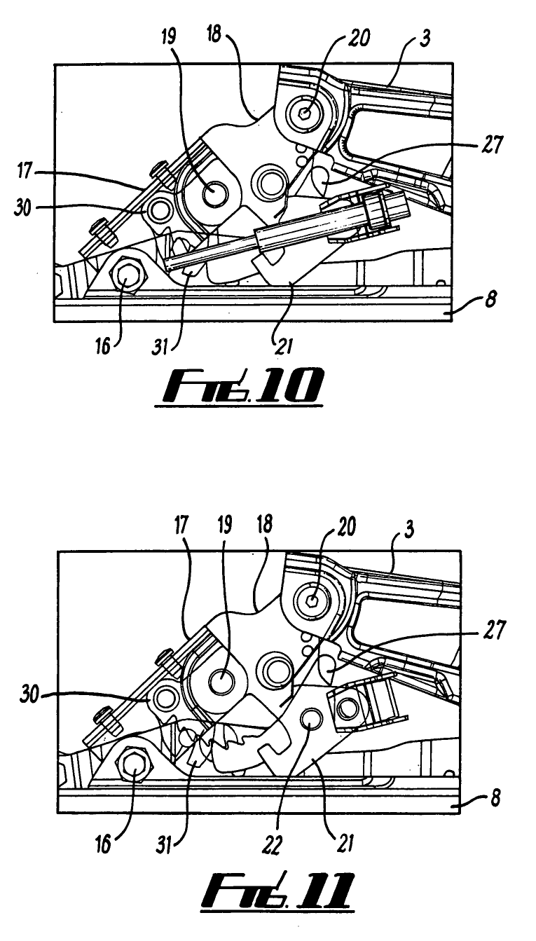

FIG. 10 shows the view of FIG. 4 with the actuator in a fully deployed state shown in FIG. 3; and

FIG. 11 shows the view of FIG. 10 without the actuator.

Referring to the figures an automotive vehicle seat comprises a cushion part 1 and a squab part 2, each having respective metal frames 3, 4 supporting upholstery 5.

The cushion 1 and squab 2 are pivotally connected together by a pivot 6 enabling the rake of the squab relative to the cushion 1 to be adjusted. A mechanism is provided to one side of the seat for adjustment of the rake of the squab 2.

The cushion frame 3 is mounted by way of a height adjustment mechanism, generally 7, to a moveable slide 8. The moveable slide 8 is slidably mounted on a fixed slide 9 which is in turn fixed to the vehicle floor. The moveable and fixed slide arrangement allows fore and aft movement of the seat relative to the vehicle. The height adjustment mechanism provides for heightwise movement of the seat relative to the floor and roof of the vehicle.

The seat includes a seat belt comprising a webbing strap 11. The seat belt is shown in a fastened state in FIG. 1, although no occupant is shown in the seat. The webbing is stored on a conventional reel housed in the seat squab 2 and pays out of an opening 12 towards the top of the seat squab 2 and can be drawn in a diagonal fashion across an occupant of the seat so that a fitting 13 slidably mounted on the webbing 11 can be engaged into a latch fastened to an anchor point towards the bottom of the squab and on the opposite side of the squab to the aperture 12 through which the webbing strap 11 is paid out. The webbing strap 11 continues from the fastening to an anchor point 14 on the cushion frame 3. The reel is of the ‘inertia’ type and arranged to lock under impact conditions to prevent further retraction of the seat belt from the reel and thus restrain movement of the seat occupant.

The front mounting of the cushion frame 3 to the movable rail 8 comprises a lower strut member 17 and an upper strut member 18. The lower strut member 17 is pivotally mounted to the movable slide 8 by pivot 16 at one end and pivotally mounted to the upper strut member at its opposite end by pivot 19. The upper strut member is in turn connected to the cushion frame 3 by pivot 20 and to a locking member 21 by pivot 22. Pivots 19,20 and 22 form the corners of a broadly equilateral triangle.

Mounted to a second pivot 23 on the locking member 21 is one end of an actuator generally 24, the opposite end of which is mounted to pivot 16. The actuator comprises a cylinder 25 and piston arrangement, the piston (not shown) being connected to a rod 26.

The cylinder contains an explosive charge which on detonation drives the piston along the cylinder 25 urging the rod 26 out of the cylinder 25.

Also mounted to pivot 22 on the upper strut member 18 is a second locking member 27. The second locking member is elongate and generally curved. It extends either side of the pivot 22. In the direction towards the seat frame 3 from the pivot 22 a return spring 28 mounted to the upper strut member bears down on the second locking member 27, urging the opposite end of the second locking member 27 upwards, the upper edge of which has a toothed profile.

First 30 and second 31 locking members are also mounted to the lower strut member 17. The lower edge of the first locking member 30 defines an upwardly extending slot and the lower edge of the second locking member 31 defines a toothed profile.

The locking member 21 of the upper strut 18 and the first locking member 30 of the lower strut 17 are arranged to engage with each other.

The normal position of the seat is shown in FIGS. 2,4 and 5. In this position the locking member 21 which defines an upwardly directed projection is engaged with the first locking member 30 of the lower strut 17, the tab of one locking member being received into the slot of the other, as indicated by arrow 30a.

Engagement of the two locking members restricts and substantially prevents relative movement of the upper 18 and lower 17 strut members.

As is common, a vehicle on which the seat is provided is equipped with one or more sensors able to determine if the vehicle is involved in an impact. In the event of circumstances indicative of a particular type of impact being detected a control unit is operative to deploy one or more safety features. In the present case it is intended that detection of the onset of a frontal impact causes the charge in the actuator 24 to be fired, causing the rod 26 to be urged out of the cylinder 25. The actuator is preferably deployed within 10 μs of the beginning of a crash event.

When the actuator is deployed it operates to urge the two points (pivots 16 and 23) at which it is mounted apart. Initially this causes the locking member 21 to rotate relative to the upper strut member 18, disengaging the tab of the locking member from the slot of the first locking member of the lower strut 17 as shown in FIGS. 6 and 7 allowing for relative movement of the two struts.

The locking member 21 rotates until pivot 22 lies on a straight line extending from pivot 16 to pivot 23. Continued movement of the actuator 24 urges pivots 16 and 23 apart causing the upper 18 and lower 17 strut members to move relative to each other, from the position shown in FIGS. 2, 4 and 5, through the position shown in FIGS. 6 and 7 and into the position shown in FIGS. 8 and 9. This has the effect of displacing the front of the seat cushion 1 upwardly away from the movable rail 9, pivoting the seat about its rear mounting causing the seat squab 2 to move backwards relative to the vehicle floor. This is seen by comparing FIGS. 2 and 3, in FIG. 3 the seat squab is displaced from the line 32.

As the actuator 24 extends the toothed profiles of the second locking members 27 and 31 of the upper 18 and lower 17 strut members respectively engage, the return spring 28 urging the two together. The two locking means act as a ratchet preventing return of the seat to its original position.

The upper strut member 18 includes a stop 33 which abuts the lower strut member when the two strut members reach relative positions at which the pivots 16 and 20 are at substantially their maximum displacement from each other preventing relative onward movement of the two members is prevented. The members become locked in the position shown in FIGS. 3, 10 and 11, movement in one direction being prevented by the stop 33 and movement in the other by the second locking members 27 and 31.

Thus the invention provides for a vehicle seat which is locked in a normal operating position until onset of an impact causes operation of an actuator. Operation of the single actuator first unlocks the seat from its normal operating position and then causes the front of the seat to be displaced upwards relative to a vehicle floor in which it is mounted to a second position in which the seat is then also locked. Displacement of the front of the seat upwards causes the seat to pivot about its rear mounting causing the seat squab to move backwards relative to the vehicle in which it is mounted. This will at least partially compensate for forward movement of the seat as a result of compliance in the seat structure under the collision conditions and therefore reduce movement and the potential for injury of a seat occupant as a result of the impact.

The above embodiment is described by way of example only. Many variations are possible without departing from the invention.

1. A vehicle seat comprising a means arranged to positively displace a part of the seat relative to either another part of the seat and/or a vehicle on which the seat is mounted in the event that predetermined conditions corresponding to a vehicle impact are encountered.

2. A vehicle seat as claimed in claim 1 wherein the means arranged to positively displace comprises an actuator.

3. A vehicle seat as claimed in claim 2 wherein the actuator is a gas operated piston and cylinder arrangement.

4. A vehicle seat as claimed in claim 2 wherein the actuator is mounted between components of the seat and/or between the seat and a vehicle on which it is mounted.

5. A vehicle seat as claimed in claim 2 wherein the actuator is arranged to operate an adjustment mechanism arranged to adjust the relative position of parts of the seat, and/or of the seat relative to a vehicle in which it is mounted.

6. A vehicle seat as claimed in claim 5 wherein the adjustment mechanism comprises two pivotally connected members, and the actuator is arranged to move the members pivotally relative to one another.

7. A vehicle seat as claimed in claim 1 further comprising a locking means operative to lock the seat and/or components of the seat in a normal and/or displaced state.

8. A vehicle seat as claimed in claim 1 wherein the seat comprises a cushion and a squab and the means is arranged to displace the front part of the cushion upwardly relative to a vehicle on which the seat is mounted.

9. A vehicle comprising a vehicle seat as claimed in claim 1.

10. A vehicle seat as claimed in claim 9 further comprising an electronic control unit arranged to trigger the means to positively displace a part of the seat in dependence upon vehicle impact conditions as sensed by one or more vehicle impact sensors.

11. (canceled)

12. (canceled)
